(19) United States
(12) Patent Application Publication
(10) Pub. No.: US 2009/0113247 A1
(43) Pub. Date: Apr. 30, 2009

(54) FAILURE DIAGNOSIS DEVICE, PROGRAM AND STORAGE MEDIUM

(75) Inventors: Akio Gofuku, Akaiwa-city (JP); Norikazu Shimada, Tokyo (JP); Seiji Koide, Yokohama (JP)

Correspondence Address: OLIFF & BERRIDGE, PLC, P.O. BOX 320850, ALEXANDRIA, VA, 22320-4850, US

(73) Assignee: National University Corporation Okayama University, Okayama-shi, Okayama (JP)

(21) Appl. No.: 11/988,444

(22) PCT Filed: Jul. 10, 2006
(86) PCT No.: PCT/JP2006/313668

§ 371 Date: Jan. 8, 2008

(30) Foreign Application Priority Data
Jul. 14, 2005 (JP) 2005-205847

(51) Int. Cl. G06F 11/07

(52) U.S. Cl. 714/37; 714/E11.029

(57) ABSTRACT

A failure diagnosis device, program and storage medium are provided, which are capable of automatically generating FTA and/or FMEA from MFM. An FTA generating section generates an FTA knowledge by reading out, from an HD, an MFM knowledge systematically and organically representing goals, functions, relations between the functions, relations between the functions and goals, and relations between the functions and components realizing the functions; an MFM attendant knowledge including a component behavior knowledge representing relations between failures and behaviors of components when failure occurs in the component; and an influence-repercussion rule defining the influence exerting when the function is changed. An FMEA generating section generates an FMEA knowledge by reading out the MFM knowledge, the MFM attendant knowledge, and the influence-repercussion rule from the HD.

### TECHNICAL FIELD

This invention relates to a failure diagnosis technique using MFM (Multilevel Flow Modeling).

### RELATED ART

Heretofore, failure diagnoses have been performed in the art for various systems such as operational support systems for space shuttles, operational systems for launching rockets, plant operation support systems, and the like. When a failure occurs in a component (device) which is one of components constructing a system, such a failure diagnosis cons and verifies a failure cause of the component and deals with troubles caused by the failure. For this purpose, diagnosis methods using FTA (Fault Tree Analysis) or FMEA (Failure Mode and Effects Analysis) have been known.

In the plant operation support system, for example, the FTA and FMEA are the diagnosis methods which are easy to be understood by general plant designers. FTA diagrams and F A diagrams are made up during plant designing stage, and used for improving the completion of design and further used for investigating the cause of an accident.

In this case, the FTA means “fault tree analysis”. According to this analysis, when a failure occurs in one of components constructing a system, the event of the failure is considered as the highest order event, and its failure cause is analyzed sequentially and inversely from its higher order to lower order in the backward direction along a fault tree in a manner correlating with one another. Moreover, the FMEA means “failure mode and effects analysis”. According to this analysis, when a failure occurs in one of components constructing a system, the effect on the functions of the system by the failure is analyzed from its failure cause toward higher order events in the forward direction from the lower order to higher order.

Failure diagnosis techniques utilizing the FTA and FMEA have been disclosed. In the failure diagnosis device of patent document 1, for example, by analyzing occurrence pathways and causes of failures during designing stage and by utilizing the FTA and FMEA in which failed states and failure causes are correlated with each other, once a state most coinciding with the actually failed state is selected, items required for searching the failure causes are automatically set. In this manner, replacement of parts by erroneous judgements and reoccurrence of failure are reduced, thereby achieving a reduction in maintenance cost.

In a failure diagnosis device in patent document 2, moreover, by using a commonly used FMEA, a modified FMEA is generated by logical processing of relational database, and parts and failures are correlated with each other to form event grouping diagrams. Further, an FTA processing is carried out to create a rule base of “If . . . , then . . . ” style. With the aid of these data, the maintenance of the system can be effected with constant criteria without depending on individual competences of designers of the system so that failure diagnoses can be performed with high accuracy.

In a failure diagnosis device in patent document 3, further, upon a failure occurring in one of components constructing a system, diagnosis of the failure is made on the basis of ontology data to indicate diagnostic contents. When a failure occurs, therefore, the failure location and treating method depending on the failure situation need no longer be searched in huge quantities of FTA data.

Patent document 1: Japanese Patent Application Laid-Open No. 1998-78,376

### Patent Document 2: Japanese Patent Application Laid-Open No. 1994-95,881

### Patent Document 3: Japanese Patent Application Laid-Open No. 2000-322,125

### DISCLOSURE OF THE INVENTION

### Problems to be Solved by the Invention

In contrast, MFM has been known as a modeling technique for expressing the design intent of a system. FIG. 1 is a drawing for explaining the MFM. The MFM is a method for modeling an engineering system in order to perform failure diagnosis using qualitative reasoning. A primary object of the MFM is to provide a basic system for using the concept of “means-ends” and “whole-parts” in designing a system. As shown in FIG. 1, the MEM expresses relations between functions for achieving goals of the system by the structure of the means and ends and also by the structure of the whole and parts. In other words, for example, a flow structure of energy, mass, activity, information and the like treated by the plant for its goal is expressed by the use of functions such as storage, balance, transport and the like and relations such as connection, condition and the like to graphically indicate relations between the functions, between the functions and goals, and between the functions and components for realizing the functions.

In this way, the MFM model is made by modeling the system along two dimensionalities of the models which are means-ends and whole-parts, by functional expression and description of physical components according to the intention of the system designer.

FIG. 2 is a diagram indicating symbols used in the MFM. In FIG. 2, the goal of a system, function, connection indicating the relations of respective functions in flow structures, and the like are indicated by symbols in order to represent the flow structures of the energy and the mass. In the symbols for functions, the “storage” indicates that the difference between input amount and output amount is stored, while the “balance” means that the total input amount and the total output amount coincide with each other, and the “transport” means movements of energy, mass and the like, respectively. The “source” indicates the start of flow, while the “sink” indicates the end of flow, and the “barrier” shows that input is stopped, respectively. In the symbols of the relations, the “condition” indicates the relation between a function and a goal achieved by the function, and the “achieve” indicates the relation between the goal and the flow structure for achieving the goal, respectively.

FIG. 3 is a systematic diagram of a high pressure gas filling plant while FIG. 4 is a diagram illustrating the plant of FIG. 3 by the MFM using the symbols shown in FIG. 2. In FIG. 3, the high pressure gas filling plant serves to control the pressure in a high pressure gas tank. In practice, the amount of supply gas is limited by a regulator, and the pressure in the high pressure gas tank is input through a pressure sensor B into a pressure control device which causes a pressure regulating valve to change its opening, thereby controlling the pressure in the high pressure gas tank. Such a high pressure gas filing plant is represented by the MFM to obtain the diagram shown in FIG. 4. The goal of the system is “high pressure gas tank is filled with gas (Filling High Pressure Gas Tank with Gas)”, and the sub-goal is “sensor device for monitoring is supplied with pressure (Pressure Supply to Monitor Sensor Device)”, “sensor device for control is supplied with pressure (Pressure Supply to Control Sensor Device)”, or the like. The flow structure of energy is expressed by function and relations.

Diagrams represented in MFM such as that shown in FIG. 4 are generally made by knowledge engineers. However, it is difficult to judge whether the MFM made by the knowledge engineers is created by exactly modeling the systems. Therefore, there has been a need for a method for proving the exactness of the models of MFM. Moreover, since the MFM is generally unfamiliar to system designers, it is also difficult for them to understand the MFM. In contrast herewith, as the FTA and FMEA described above are methods usually used by them, it is easy for them to understand the FTA and FMEA. Usually, the system designers themselves make the FTA and FMEA and use these analyses for confirming and verifying failure causes. Under such circumstances, it is desirable to automatically make the FTA and FMEA from the MFM and to utilize the automatically made FTA and FMEA effectively.

And so, the invention has been completed to solve the task described above, and has an object to provide a failure diagnosis device, program and storage medium which are capable of automatically generating FTA and/or FMEA from the MFM.

### Means for Solving the Problem

According to the invention, the failure diagnosis device for generating information for failure diagnosis of a system by the use of MFM, comprises a storage section and an FMEA generating section, said storage section that stores: an MFM knowledge representing a flow structure achieving a goal of the system by the use of functions of components constructing said system; a component behavior knowledge including behavior changes, failure modes and failure causes when a failure occurs in a component; a dangerous situation knowledge including dangerous situations of the system, components causing said dangerous-situations, and order of priority of said dangerous situations; an influence-repercussion rule that defines influence exerting when the function changes; an operation knowledge including operations of the components and behaviors caused by the operations; a request-repercussion rule that defines repercussion when request for function changes; and a function-goal knowledge representing achievement rate of the goal in a qualitative or quantitative function with respect to the change in function, and said FMEA generating section for generating an FMEA knowledge, that performs procedures of: reading out the component behavior knowledge from said storage section, and extracting the component, the failure mode and the failure cause included in said component behavior knowledge; reading out the MFM knowledge, the influence-repercussion rule, and the function-goal knowledge from said storage section, propagating behavior change of said extracted failure cause along the flow structure of the MFM knowledge in accordance with the influence-repercussion rule on the assumption that all the components except for the component of the failure cause normally operate, and deducing change in achievement rate of a goal to be achieved by function flow from the function-goal knowledge to set said change in achievement rate of the goal as the influence affecting the system; setting the number of failure causes giving rise to dangerous situation by said extracted failure mode as the number of failure causes for respective failure modes from the component behavior knowledge; reading out the dangerous situation knowledge from said storage section, and setting order of priority of dangerous situations included in said dangerous situation knowledge as danger priority; reading out the operation knowledge and the request-repercussion rule from said storage section, propagating a request for behavior change along the flow structure of the MFM knowledge in accordance with the request-repercussion rule, propagating influence when the request is fulfilled along the flow structure of the MFM knowledge in accordance with the influence-repercussion rule, and setting operation realized by the component included in the operation knowledge as counter operation for avoiding the dangerous situation; propagating behavior change of said extracted failure cause along the flow structure of the MFM knowledge in accordance with said influence-repercussion rule, and setting behavior of the component as object of the propagation as a method for sensing the failure cause; and generating the FMEA knowledge including the extracted component, the extracted failure mode, the extracted failure cause, the set influence affecting the system, the number of failure causes, the danger priority, the counter operation and the method for sensing.

According to the invention, the failure diagnosis device further comprises an FTA generating section for generating an FTA knowledge, said FTA generating section performing procedures of: setting the dangerous situation of the system included in said dangerous situation knowledge to the highest order event of FTA; propagating behavior change of the function of the component of said highest order event along the flow structure of the MFM knowledge, and setting a request for achievement rate of the goal of the system to the intermediate order event of the FTA in accordance with said propagated behavior change; setting the failure cause for the propagated behavior change to the lowest order event of the FTA referring to said component behavior knowledge; and generating the FTA knowledge including the dangerous situation of the system set to said highest order event, the request for achievement rate of the goal of the system set to the intermediate order event, and the failure cause set to the lowest order event.

### EFFECT OF THE INVENTION

According to the invention, the FTA and/or FMEA are automatically generated from the MFM. Using these analyses, system designers confirm the automatically generated FTA and/or FMEA so that they can verify the exactness of models of the MFM. Moreover, since system designers themselves need no longer make the FTA and/or FMEA, labor hours for making these analyses can be saved. Therefore, it becomes possible to use the automatically generated FTA and/or FMEA effectively.

### BRIEF DESCRIPTION OF THE DRAWINGS

FIG. 1 is a drawing for explaining the MFM;

FIG. 2 is a view illustrating symbols used in the MFM;

FIG. 3 is a systematic diagram of a high pressure gas filling plant;

FIG. 4 is an MFM diagram of the high pressure gas plant shown in FIG. 3;

FIG. 5 is a view illustrating the construction of the hardware of a failure diagnosis device according to an embodiment of the invention;

FIG. 6 is a diagram illustrating the functional construction of the failure diagnosis device according to the embodiment of the invention;

FIG. 7 is a diagram showing the functional configuration of an FMEA generating section;

FIG. 8 is a table showing the kinds and description of an MFM attendant knowledge;

FIG. 9 is one example of drawing for setting an operation knowledge;

FIG. 10 is a table showing the configuration of a component behavior knowledge;

FIG. 11 is a table showing the configuration of an influence-repercussion rule;

FIG. 12 is an MFM diagram for explaining the propagation of behavior change;

FIG. 13 is an FTA diagram;

FIG. 14 is an FMEA diagram; and

FIG. 15 is a table showing a request-repercussion rule.

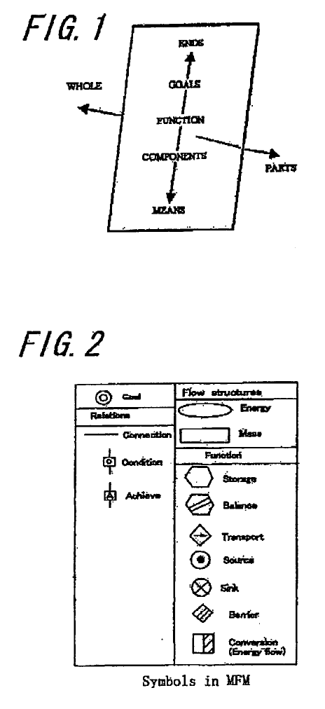

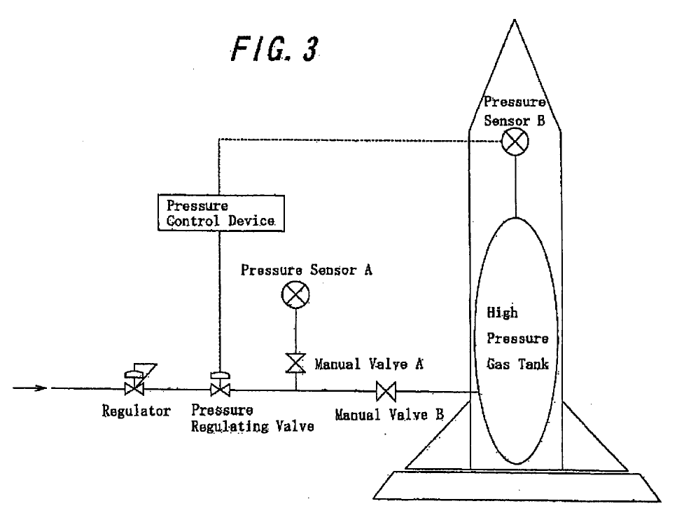

### DESCRIPTION OF THE REFERENCE NUMERALS

1 Failure diagnosis device
2 CPU
3 RAM
4 ROM
5 HD
6 I/F
7 Display
8 Mouse
9 Keyboard
10 FTA generating section
20 FMEA generating section
21 Device-failure mode-and failure cause-extracting means
22 Danger-forecasting and-deducing means
23 Counter operation-conducting and-deducing means
24 Failure cause-narrowing down and-deducing means
30 MFM knowledge
40 MFM attendant knowledge
41 Behavior knowledge
42 Function-goal knowledge
43 Goal-function knowledge
44 Operation knowledge
45 Component behavior knowledge
46 Dangerous situation knowledge
50 Influence-repercussion rule
60 FTA knowledge
70 FMEA knowledge

### BEST MODE FOR CARRYING OUT THE INVENTION

An embodiment of the invention will be described in detail with reference to the drawings hereinafter.

### [Construction]

FIG. 5 is a view illustrating the construction of the hardware of a failure diagnosis device according to the embodiment of the invention. The failure diagnosis device 1 comprises a CPU 2 for performing a processing according to a program, a RAM 3 for temporarily storing programs and data, a ROM 4 for storing system programs such as operating systems and system data, an HD 5 for storing programs and data for carrying out processing and various kinds of information such as MFM knowledge, MFM attendant knowledge and the like, a display 7 for displaying FTA knowledge and FMEA knowledge generated by the CPU 2 as FTA and FMEA diagrams on a screen, a mouse 8 for inputting instructional information from an operator, a keyboard 9, and an I/F (interface) 6 for relaying the indicator 7 and the like. The CPU 2 inputs the instructional information from the operator using the mouse 8 and the keyboard 9 through the I/F 6, executes programs according to the instructional information, reads out the MFM knowledge and the like stored in the HD 5, generates the FTA knowledge and FMEA knowledge, and displays these on the indicator 7. In other words, the CPU 2 reads out failure diagnosis programs from the HD 5 for carrying out a series of processing later described, develops these programs on the RAM 3, performs these programs, and stores the obtained results in the HD 5 or displays the results on the indicator 7.

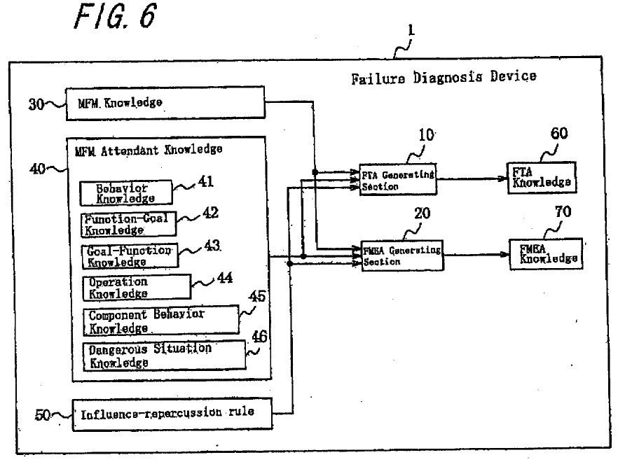

FIG. 6 is a diagram illustrating the functional construction of the failure diagnosis device 1 according to the embodiment of the invention. The failure diagnosis device 1 comprises an FTA generating section 10, an FMEA generating section 20, an MFM knowledge 30, an FTA attendant knowledge 40, an influence-repercussion rule 50, an FTA knowledge 60, and an FMEA knowledge 70. Correlating the configuration shown in FIG. 6 with that of the hardware shown in FIG. 5, the FTA generating section 10 and the FMEA generating section 20 correspond to the function section that the CPU 2 reads out the failure diagnosis programs from the HD 5 to perform the processing. The MFM knowledge 30, the MFM attendant knowledge 40, and the influence-repercussion rule 50 are stored in the HD 5, and the FTA knowledge 60 is generated by the FTA generating section 10 and stored in the HD 5. The FMEA knowledge 70 is generated by the FMEA generating section 20 and stored in the HD 5.

The FTA generating section 10 reads out the MEM knowledge 30, the MFM attendant knowledge 40, and the influence-repercussion rule 50 from the HD 5 to generate the FTA knowledge 60 which is stored in the HD 5. The FMEA generating section 20 reads out the MFM knowledge 30, the MFM attendant knowledge 40, and the influence-repercussion rule 50 from the HD 5 to generate the FMEA knowledge 70 which is stored in the HD 5. The FTA generating section 10 and the FMEA generating section 20 will be described in detail later.

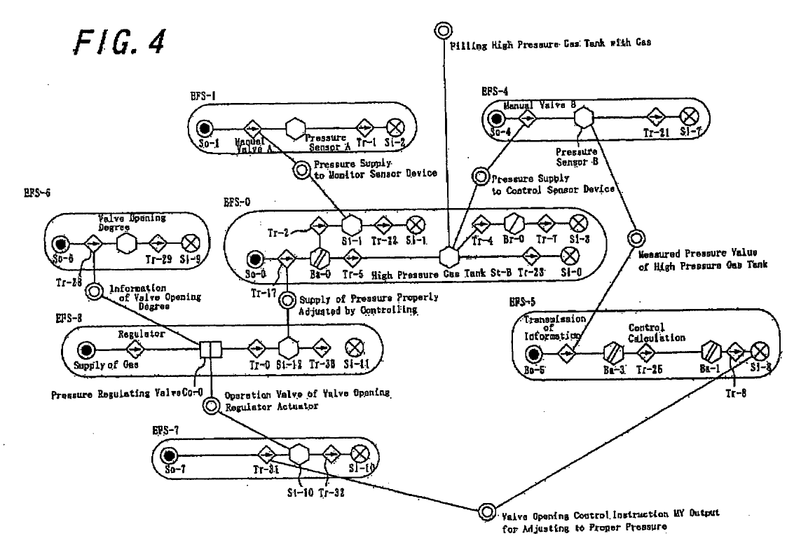

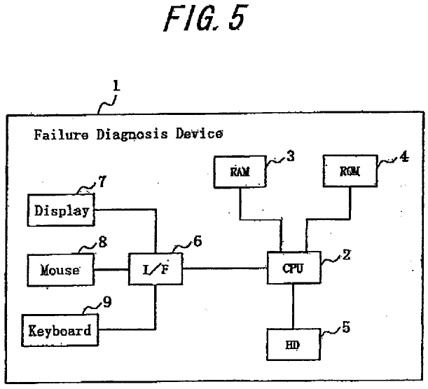

The MEM knowledge 30 is apiece of information systematically and organically expressing goals, functions, relations between the functions, relations between the functions and goals, and relations between the functions and components for implementing the functions as the MFM diagram shown in FIG. 4. The MFM knowledge 30 is input through the mouse 8 and the keyboard 9 by operator's operations and stored in the HD 5.

The MFM attendant knowledge 40 is a piece of information attending on the MFM knowledge 30 and includes a behavior knowledge 41, a function-goal knowledge 42, a goal-function knowledge 43, an operation knowledge 44, a component behavior knowledge 45, and a dangerous situation knowledge 46. The MFM attendant knowledge 40 is input through the mouse 8 and the keyboard 9 by operator's operations and stored in the HD 5.

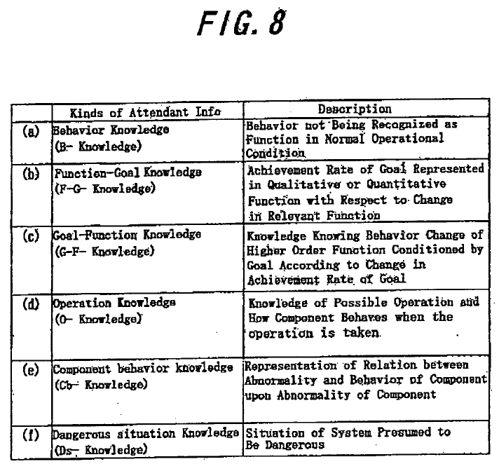

FIG. 8 is a table showing the kinds and description of the MFM attendant knowledge 40. The MFM attendant knowledge 40 will be described hereinafter.

(a) The behavior knowledge (B-Knowledge) 41 is a piece of information of behavior which could not be recognized as a function in a normal operational condition. In the MFM, any function having nothing to do with achievement of a goal is not expressed basically. For example, devices for constructing a plant include functions for avoiding failed conditions, and such functions have nothing to do with the achievement of the goal so that such functions are not represented in the MFM diagram. However, devices whose functions are not represented could be operated to deal with a failure. In such a case, the information concerning the functions of such devices is treated as a behavior knowledge (B-Knowledge) 41.

(b) The function-goal knowledge (F-G-Knowledge) 42 is a piece of information which represents an achievement rate of the goal in a qualitative or quantitative function (mathematical term) with respect to change in the relevant function. In the MFM diagram shown in FIG. 4, for example, in the case of the relation “connection” between the goal “supply of pressure properly suited by controlling” and the function “transport Tr-17” shown in the center of FIG. 4, described as the function-goal knowledge 42 is an information of qualitative value propagation rule such as “qualitative value of function is transmitted to the goal without any modification”, “qualitative value of function is transmitted to goal adversely”, or the like.

(c) The goal-function knowledge (G-F-Knowledge) 43 is a piece of information which represents change in behavior of the higher order function conditioned by a goal according to change in achievement rate of the goal.

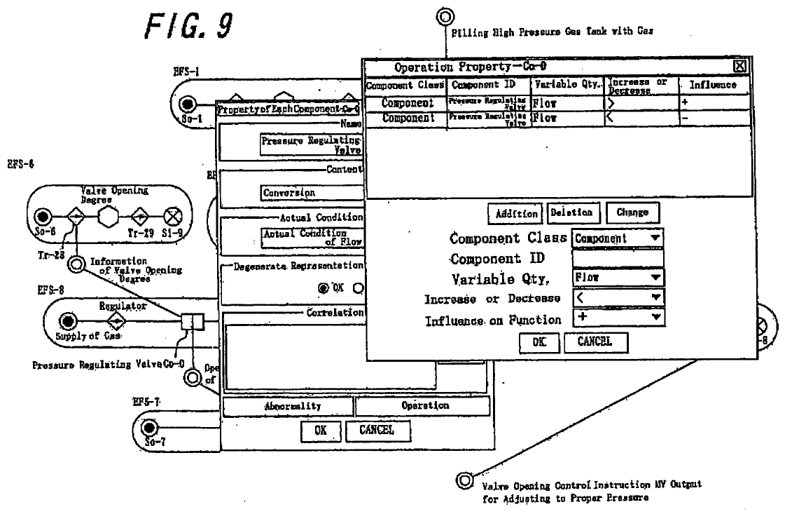

(d) The operation knowledge (O-Knowledge) 44 is a piece of information which represents how the function of a component quantitatively varies when the component is operated. FIG. 9 is one example of drawing for setting the operation knowledge (O-Knowledge) 44. The drawing shown in FIG. 9 is displayed on the display 7, and the operation knowledge (O-Knowledge) 44 is set through the mouse 8 and the keyboard 9 by the operator. In this example, in the case that a pressure regulating valve is operated in its opening direction, the flow rate is qualitatively increased (+) as the corresponding function of the pressure regulating valve (refer to the bottom left portion in the MFM diagram shown in FIG. 4). In the case that the pressure regulating valve is operated in its closing direction, the flow rate is qualitatively decreased (−) as the corresponding function of the pressure regulating valve. These phenomena are set as the operation knowledge (O-Knowledge) 44.

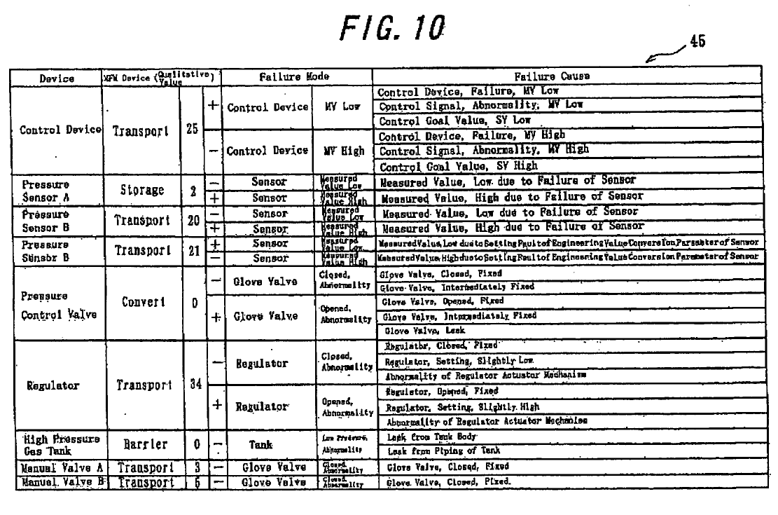

(e) The component behavior knowledge (Cb-Knowledge) 45 is a piece of information representing the relation between a failure and behavior of a component, when the failure occurs in the component. In other words, the component behavior knowledge (Cb-Knowledge) 45 is the information representing how the function of the failed component behaves qualitatively thereafter. FIG. 10 is a table showing the configuration of the component behavior knowledge (Cb Knowledge) 45. The component behavior knowledge 45 comprises devices (components), functions of MFM, indexes of these functions, qualitative moving directions (behavior) of the functions, failure modes, and failure causes. For example, the “control device” (refer to “control calculation Tr-25” at lower right of MFM diagram of FIG. 4) is “transport” in the MFM, and its index is “25”. When the qualitative value increases (+), the failure mode is “control device, MV low”, and the failure cause is “control device, failure, MV low”, “control signal, abnormality, MV low”, or “control goal value, SV low”. When the qualitative valve decreases (−), the failure mode is “control device, MV high”, and the failure cause is “control device, failure, MV high”, “control signal, abnormality, MV high”, or “control goal value, SV high”.

(f) The dangerous situation knowledge (Ds-Knowledge) 46 is a piece of information which represents information of systems presumed to be dangerous together with orders of priority. For example, the information is “pressure of a high pressure gas tank is high, (storage 8, +)”, or “pressure of a high pressure gas tank is low, (storage 8, −)”.

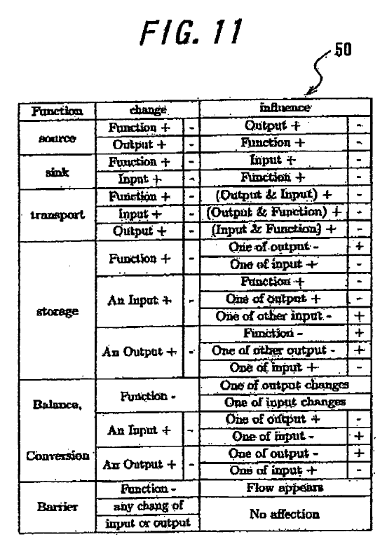

The influence-repercussion rule 50 is a piece of information that when the function changes, the influence caused by the change of the function is defined, and the information is input through the mouse 8 and the keyboard 9 by operator's operation. FIG. 11 is a table showing the configuration of the influence-repercussion rule 50. The influence-repercussion rule 50 comprises function, change, and influence. For example, in the case that the function is “source”, when the qualitative value of the function increases (+), its influence indicates that the qualitative value of output of function increases (+), while when the qualitative value of the function decreases (−), its influence indicates that the qualitative value of output of function decreases (−). On the other hand, when the qualitative value of the output of the function increases (+), its influence indicates that the qualitative value of the function increases (+), and when the qualitative value of the output of the function decreases (−), its influence indicates that the qualitative value of the function decreases (−). In the case that the function is “storage”, when the qualitative value of the function increases (+), its influence indicates that one qualitative value of the output decreases (−), or one qualitative value of the input increases (+).

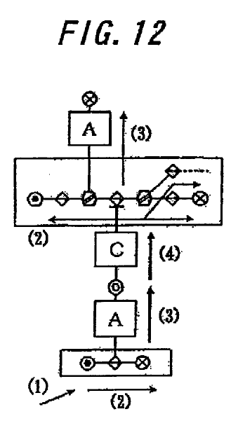

The FTA generating section 10 and the FMEA generating section 20 propagate behavior changes as to the MFM knowledge 30 and the MFM attendant knowledge 40 in accordance with the influence-repercussion rule 50. FIG. 12 is an MFM diagram for explaining the propagation of behavior change. The propagation processing of the behavior change is shown in the following (1) to (5).

(1) Behavior of a component is obtained.

(2) Concerning changes caused by the behavior of the component, the behavior change is propagated according to the influence-repercussion role 50 in the whole flow structure to which the changing function belongs. In FIG. 12, the behavior change is propagated to the “source”, “transport” and “sink”. For example, in the event that behavior change of increase (+) occurs in the qualitative value of the function of source, the qualitative value of output increases (+) by the influence, referring to the influence-repercussion rule 50 shown in FIG. 11. In the MFM diagram of FIG. 12, further, the influence is propagated to the transport next to the source, and the influence causes qualitative values of the output and function to increase (+) in accordance with the influence-repercussion rule 50. Further, the influence is propagated to the goal and the sink. In this manner, the behavior change is propagated in accordance with the influence-repercussion rule 50.

(3) The behavior change is propagated to the goal. In FIG. 12, the behavior change is propagated from the transport to the goal, thereby achieving the propagation to the goal.

(4) The behavior change is propagated from the goal to higher order function. In FIG. 12, the behavior change is propagated from the goal to the transport, thereby achieving the propagation to the higher order function.

(5) When the behavior change has been propagated to the highest order goal, the propagation of the behavior change is terminated. In the case that the behavior change is not propagated to the highest order goal, it returns to (2). In FIG. 12, when the behavior change is propagated to the goal shown in the highest portion of the MFM diagram, the propagation processing for the behavior change is terminated.

In the case that behavior change is propagated in an MFM model having a loop, the influence on the same function is deduced again after making a circuit of the loop. In this case, (a) the same influence as the qualitative influence deduced in the previous time is deduced, or (b) influence different from (contrary to) the influence in the previous time is deduced. In the case (a), as the same result is obtained even if the deduction is continued, the deduction is terminated. In the case (b), as it becomes a qualitatively conflicting result, the deduction is terminated. Which case may occur could not be determined by a qualitative method.

[Generation of an FTA Diagram]

The action of the FTA generating section 10 will then be described in detail. The FTA generating section 10 is operated as follows. The MFM knowledge 30, the MFM attendant knowledge 40 and the influence-repercussion rule 50 are input into the FTA generating section 10 which sets the dangerous situation of the system, which is the dangerous situation knowledge (Ds-Knowledge) 46, as the highest order event of the FTA. Further, the FTA generating section 10 causes the behavior change to propagate from the function of the dangerous situation of the system toward its upstream or downstream in accordance with the influence-repercussion rule 50 so that the function having a goal and a failure knowledge is set as an event of the FTA. In this manner, the FTA generating section 10 creates the FTA knowledge 60.

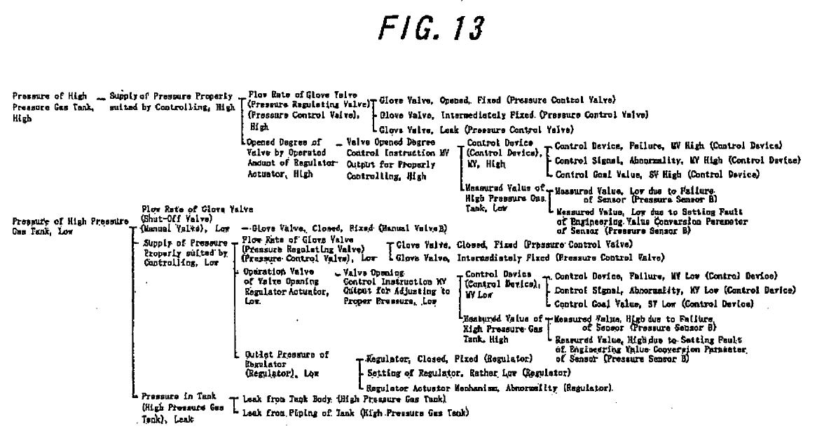

FIG. 13 is an FTA diagram generated in the case that the dangerous situation knowledge (Ds-Knowledge) 46 is “pressure of high pressure gas tank is high, (storage 8, +)” and “pressure of high pressure gas tank is low, (storage 8, −)”. In FIG. 13, “pressure of high pressure gas tank is high” and “pressure of high pressure gas tank is low” are set as the highest order events on the left side in FIG. 13. Respectively set in FIG. 13 are events obtained by propagating the behavior change of the storage which is the function of the component “high pressure gas tank St-8” in the highest order event, toward the upstream or downstream. The events set in the right side in FIG. 13 are the failure causes of the component behavior knowledge (Cb-Knowledge) 45 shown in FIG. 10.

The FTA generating section 10 performs the following processing.

(1) The highest order events of FTA, “pressure of high pressure gas tank is high” and “pressure of high pressure gas tank is low” are set from the dangerous situation knowledge (Ds-Knowledge) 46.

(2) As described above, the behavior changes of “pressure of high pressure gas tank is high” and “pressure of high pressure gas tank is low” are propagated from the storage which is the function of the component “high pressure gas tank St-8” of the highest order event in accordance with the influence-repercussion rule 50 shown in FIG. 11. In this case, the behavior changes are propagated to the function of balance or storage, and when the function has a plurality of inputs or outputs, propagation is divided into the case that going back output request is propagated to only one of the inputs and the other case that the output request is propagated to only one of the outputs, and the behavior change is propagated in parallel for each case.

(3) Whether a component realizing the function complies with the request for behavior change is judged by referring to the component behavior knowledge (Cb-Knowledge) 45, and in the case that the component complies with the request, the behavior change is set to an end event (the lowest order event) of the FTA. Referring to FIGS. 4, 10 and 13, the behavior change is propagated to the conversion which is the function of the “pressure control valve Co-0”, and since its qualitative value increases (+), the request for the behavior change of the component is fulfilled. Therefore, the end events of the FTA are “globe valve, opened, fixed”, “glove valve, intermediately fixed”, and “globe valve, leak” which are failure causes in the case that the qualitative value of the function of the “pressure control valve Co-0” shown in FIG. 10 increases (+).

(4) When the behavior change is propagated to a function, if the function has been conditioned by the goal, the behavior change is propagated to the upstream function so that the behavior change is converted to a request for achievement rate of the goal performing the conditioning by the use of the function-goal knowledge (F-G-Knowledge) 42 or the goal-function knowledge (G-F-Knowledge) 43, and the converted request is set to the intermediate order event of the FTA, and processing is returned to (2). Referring to FIGS. 4 and 13, since the function “transport Tr-17” at the right side of the center of FIG. 4 is conditioned by the goal “supply of pressure properly suited by controlling”, the behavior change is propagated to the goal on the upstream side. Moreover, when “(+)” has been set in the function-goal knowledge (F-G-Knowledge) 42 or the goal-function knowledge (G-F-Knowledge) 43, by means of it a conversion is effected to the request for achievement rate of goal “supply of pressure properly suited by controlling is high”, and the converted request is set to the intermediate order event which is second from the right in the upper tree in FIG. 13.

(5) In the case that there is a function on the upstream side, or there is no goal which performs conditioning, the processing is terminated. In the case that there is a function on the upstream side, or there is a goal which performs conditioning, the processing is returned to (2).

In this manner, the FTA generating section 10 sets the dangerous situation of the system, which is the dangerous situation knowledge (Ds-Knowledge) 46, to the highest order event of the FTA, and causes the behavior change to propagate by settling the function of the highest order event as a base point in accordance with the influence-repercussion rule 50 so that the function having a goal and a failure knowledge is set to an event of the FTA, thereby generating the FTA knowledge 60. The generated FTA knowledge 60 is displayed on the display 7 as the FTA diagram shown in FIG. 13.

[Generation of an FMEA Diagram]

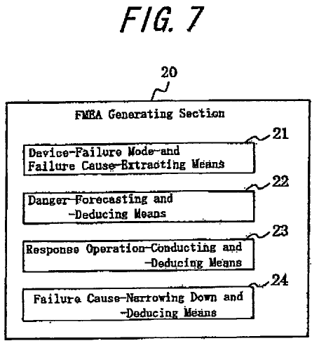

The function of the FMEA generating section 20 will then be described in detail. FIG. 7 is a diagram showing the functional configuration of the FMEA generating section 20. The FMEA generating section 20 comprises device-failure mode-and failure cause-extracting means 21, danger-forecasting and-deducing means 22, counter operation-conducting and-deducing means 23, and failure cause-narrowing down and-deducing means 24. The MFM knowledge 30, the MFM attendant knowledge 40, and the influence-repercussion rule 50 are input into the FMEA generating section 20 to set FMEA events, thereby generating the FMEA knowledge 70.

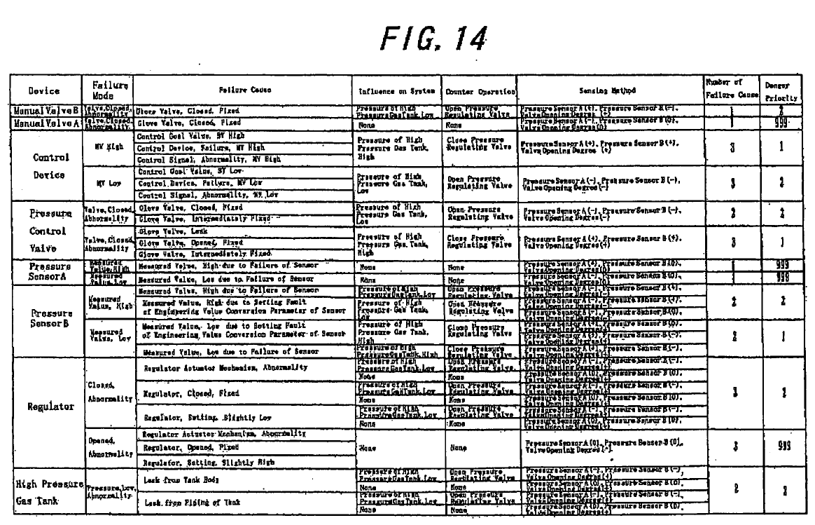

FIG. 14 is an FMEA diagram. This FMEA diagram consists of events of devices (components), failure modes, failure causes, influence on the system, counter operations, sensing methods, the number of failure causes, and danger priority. The devices, the failure modes, and the failure causes correspond to the devices, the failure modes and the failure causes shown in FIG. 10 respectively. Moreover, the “influence on the system” means the dangerous situation of the system caused by the failure mode, and the “counter operation” means the method for avoiding the dangerous situation. The “sensing method” means the method for sensing the failure cause, while the “number of failure causes” means the probability of failure occurrence, and the “danger priority” means the fatal rate given to the system by the dangerous situation. In this case, the number of failure causes is the number of failure causes which bring the system into the dangerous situations by failure modes. The danger priority is the order of priority which has been set in the dangerous situation knowledge (Ds-Knowledge) 46. In FIG. 14, moreover, for example, the sensing method for the case of the pressure sensor A (+), the pressure sensor B (−), and valve opening (+) is the method for sensing the failure cause “globe valve, closed, fixed”. In other words, when under the condition of the pressure sensor A (+), the pressure sensor B (−), and the valve opening (+), it is indicated that the failure cause of “globe valve, closed, fixed” will occur.

The device-failure mode-and failure cause-extracting means 21 of the FMEA generating section 20 extracts the device, its failure mode, and failure cause of the failure mode from the component behavior knowledge (Cb-Knowledge) 45 (refer to FIG. 10). The danger-forecasting and-deducing means 22 forecasts and deduces the danger for each of failure causes to obtain the influence on the system. Then, the means 22 calculates the number of failure causes for each of failure modes from the component behavior knowledge (Cb-Knowledge) 45 to obtain the number of failure causes. Further, the order of priority (danger priority) in the influence on the system is obtained from the dangerous situation knowledge (Ds-Knowledge) 46 for each of failure modes. The counter operation-conducting and-deducing means 23 conducts and deduces an operation for solving the failure to obtain a counter operation. The failure cause-narrowing down and-deducing means 24 narrows down and deduces the failure cause to obtain a pattern of sensor qualitative value as a sensing method. The FMEA generating section 20 generates the FMEA knowledge 70 from the device, failure mode and failure cause extracted by the device-failure mode-and failure cause-extracting means 21, and from the influence on the system, the number of failure causes, danger priority, counter operation and sensing method obtained by the danger-forecasting and-deducing means 22, the counter operation-conducting and-deducing means 23, and the failure cause-narrowing down and-deducing means 24, and displays the generated FMEA knowledge 70 on the display 7 as an FMEA diagram.

The processing for forecasting and deducing of the danger carried out by the danger-forecasting and-deducing means 22 will be described. In forecasting and deducing the danger, it is assumed that the failure cause is limited to one location and the components other than the failed component are normally operating. The qualitative situation of the failure (behavior change) is propagated from the location of the failure cause as a starting point using the MFM diagram. And qualitative influence affecting the goal and behavior of the system by the failure cause is obtained, and the obtained qualitative influence is determined to be the influence affecting the system. In practice, the danger-forecasting and-deducing means 22 performs the following processes (1) to (6).

(1) Behavior of failed component is obtained from the component behavior knowledge (Cb-Knowledge) 45.

(2) Which of functions will change and how these functions will change are deduced from the types of behavior changes (mass, energy, information, activity, and the like) and from the function which the failed component realizes.

(3) The behavior change is propagated on the basis of the rule of each of functions in accordance with the influence-repercussion rule 50 shown in FIG. 11 with respect to the whole flow structure to which the function to be changed belongs. In this case, when there is a branch of output in the functions of balance and storage, it is assumed that only one of the outputs is influenced so that cases are divided, and the propagation is effected for each case.

(4) Change in achievement rate of goal to be achieved by the flow of function is deduced from the function-goal knowledge (F-G-Knowledge) 42, and the deduced change is set as the influence affecting the system. If the goal is in the highest order, the deduction is terminated. If not in the highest order, the processing is returned to (2).

(5) The behavior change of the higher order function which is conditioned by the goal by change in achievement rate of the goal is obtained from the goal-function knowledge (G-F-Knowledge) 43.

(6) The processing is returned to (3).

In the case that the behavior change is propagated to a model having a loop in the relation between the goal and the function, moreover, the influence for the same function is deduced again after making a circuit of the loop. In this case, (a) the influence the same as the qualitative influence deduced in the previous time is deduced again, or (b) the influence different from (contrary to) the influence in the previous time is deduced. In the case (a), even if the deduction is continued, the same result is obtained. Therefore, the deduction is terminated. In the case (b), as a qualitatively conflicting result occurs, the deduction is terminated. However, since it is impossible to judge which result comes out by the qualitative method, the deduced results are not used for conducting the goal to be restored, determining the priority of behavior, and conducting the counter operations. In this manner, the influence affecting the system is obtained by forecasting and deducing the danger by means of the danger-forecasting and-deducing means 22.

The processing for conducting and deducing the counter operation carried out by the counter operation-conducting and-deducing means 23 will then be described. The processing for conducting and deducing the counter operation is performed in the qualitative direction for restoring the dangerous situation to the normal value on the basis of the deduced result and the knowledge concerning the dangerous situation of the system until the operation of the component is found on the model. When it is found, the found operation is nominated for the counter operation to deduce the operation for avoiding the dangerous situation of the system. The counter operation-conducting and-deducing means 23 determines one of the highest order of priority for restoring the goal or situation to the normal on the basis of the priority from the dangerous situation knowledge (Ds-Knowledge) 46. Further, the counter operation is searched on the MFM diagram from the goal or behavior toward the higher order or lower order, thereby obtaining the counter operation for restoration.

In practice, the counter operation-conducting and-deducing means 23 performs the following processes (1) to (5).

(1) In the case restoring the achievement rate of the goal, the function-goal knowledge (F-G-Knowledge) 42 is adversely used to be converted to change in associated function flow.

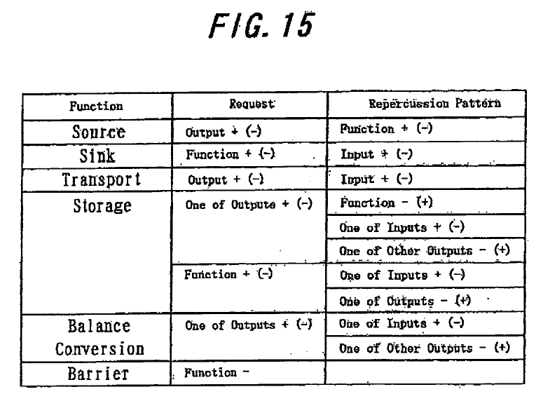

(2) The request for behavior change is propagated to the upstream based on the request-repercussion rule shown in FIG. 15 in the flow structure from the associated function flow or the function to be restored. At this point, the request-repercussion rule has been stored in the HD 5 so that the FMEA generating section 20 reads out the request-repercussion rule. In the case that the function of the balance or storage has a plurality of inputs or outputs, the propagation is divided into the case that going back output request is propagated to only one of the inputs and the other case that the output request is propagated to only one of the outputs, and the request for behavior change is propagated in parallel for each case. After the request for output has been propagated, the inevitable influence when the request is fulfilled is propagated from the upstream to the downstream on the basis of the influence-repercussion rule 50 shown in FIG. 11.

(3) In the case that there is counter operation fulfilling the request for behavior change in the component realizing the function referring to the operation knowledge (O-Knowledge) 44 and realizing relation, this operation is nominated for the counter operation.

(4) In the case that the function is conditioned by the goal, the request for behavior change is propagated to the upstream function, while the goal-function knowledge (G-F-Knowledge) 43 is adversely used to convert it to the request for achievement rate of the goal which performs conditioning the request for behavior change, and thereafter the processing is returned to (1).

(5) In the case that there is no upstream function, or no goal performing the conditioning, the processing is terminated. In the case other than his case, the processing is returned to (2).

Moreover, in the case that there is a loop in the relation between the goal and the function, its processing is the same as that described above. In this way, the counter operation-conducting and-deducing means 23 performs the operation for conducting and deducing the counter operation to obtain the required counter operation.

The processing for narrowing down and deducing failure causes carried out by the failure cause-narrowing down and-deducing means 24 will then be described. In performing the narrowing down and deducing failure causes, as to all the failure causes set in the component behavior knowledge (Cb-Knowledge) 45, qualitative values of failures are propagated to deduce the qualitative situation of the system. Further, the qualitative situation is compared with signal value of the system to judge one of the higher degree of similarity to be failure cause. In other words, the failure cause is settled as a base point, and the behavior change is propagated along the flow structure of the MFM diagram shown in FIG. 4 in accordance with the influence-repercussion rule 50 shown in FIG. 11. In the component into which the behavior change has been propagated, if the component is a sensor or the like, the pattern of the qualitative values of the sensor or the like whose influence-repercussion is (+) or (−) is obtained as a sensing method.

In practice, the following processes (1) to (3) are carried out.

(1) The signal value of the system is evaluated on the model.

(2) The influence repercussion by the given nominated failure cause is evaluated.

(3) By comparing these evaluated values, one of higher degree of similarity is judged to be the failure cause.

In order to evaluate the situation of the system with respect to the function, how the measured signal values and function model are correlated with each other is important. In general, the function is correlated with some system parameters, and the achievement Tate of the function is a function (mathematical term) of the parameters. In the MFM, moreover, the function is expressed with respect to mass, energy and the like, and is closely correlated with their flowing condition. Therefore, variables representative of flows of mass and energy most exactly indicating achievement rates of respective functions are previously made to correspond to the functions, and the achievement rates of the functions are estimated by the corresponding variables.

In this manner, the failure cause-narrowing down and-deducing means 24 performs the processing for narrowing down and deducing the failure cause to obtain the pattern of sensor qualitative values as sensing method.

Moreover, the failure diagnosis device 1 is constructed by the computer comprising the volatile storage mediums such as the CPU 2, RAM 3 and like and the nonvolatile storage mediums such as the ROM 4 and the like, the inputting devices such as the keyboard 9, pointing devices and the like, the display 7 for displaying images and data, and the interface for communicating with external devices. In this case, the respective functions of the FTA generating section 10 and the FMEA generating section 20 are implemented by causing the CPU 2 to execute the programs in which these functions are described. These programs can be distributed by storing these programs in a recording medium such as a magnetic disk (floppy disk, hard disk and the like), optical disk (CD-ROM, DVD and the like), semiconductor memory, and the like.

1. A failure diagnosis device for generating information for failure diagnosis of a system by the use of MFM, comprising a storage section and an FMEA generating section,
said storage section that stores:
an MFM knowledge representing a flow structure achieving a goal of the system by the use of functions of components constructing said system;
a component behavior knowledge including behavior changes, failure modes and failure causes when a failure occurs in a component;
a dangerous situation knowledge including dangerous situations of the system, components causing said dangerous situations, and order of priority of said dangerous situations;
an influence-repercussion rule that defines influence exerting when the function changes;
an operation knowledge including operations of the components and behaviors caused by said operations;
a request-repercussion rule that defines repercussion when request for function changes; and
a function-goal knowledge representing achievement rate of the goal in a qualitative or quantitative function with respect to the change in function, and
said FMEA generating section for generating an FMEA knowledge, that performs procedures of:
reading out the component behavior knowledge from said storage section, and extracting the component, the failure mode and the failure cause included in said component behavior knowledge;
reading out the MFM knowledge, the influence-repercussion rule, and the function-goal knowledge from said storage section, propagating behavior change of said extracted failure cause along the flow structure of the MFM knowledge in accordance with the influence-repercussion rule on the assumption that all the components except for the component of the failure cause normally operate, and deducing change in achievement rate of a goal to be achieved by function flow from the function-goal knowledge to set said change in achievement rate of the goal as the influence affecting the system;
setting the number of failure causes giving rise to dangerous situation by said extracted failure mode as the number of failure causes for respective failure modes from the component behavior knowledge;
reading out the dangerous situation knowledge from said storage section, and setting order of priority of dangerous situations included in said dangerous situation knowledge as danger priority;
reading out the operation knowledge and the request-repercussion rule from said storage section, propagating a request for behavior change along the flow structure of the MFM knowledge in accordance with the request-repercussion rule, propagating influence when the request is fulfilled along the flow structure of the MFM knowledge in accordance with the influence-repercussion rule, and setting operation realized by the component included in the operation knowledge as counter operation for avoiding the dangerous situation;
propagating behavior change of said extracted failure cause along the flow structure of the MFM knowledge in accordance with said influence-repercussion rule, and setting behavior of the component as object of the propagation as a method for sensing the failure cause; and
generating the FMEA knowledge including the extracted component, the extracted failure mode, the extracted failure cause, the set influence affecting the system, the number of failure causes, the danger priority, the counter operation, and the method for sensing.

2. The failure diagnosis device as claimed in claim 1, further comprising an FTA generating section for generating an FTA knowledge,
said FTA generating section performing procedures of:
setting the dangerous situation of the system included in said dangerous situation knowledge to the highest order event of FTA;
propagating behavior change of the function of the component of said highest order event along the flow structure of the MFM knowledge, and setting a request for achievement rate of the goal of the system to the intermediate order event of the FTA in accordance with said propagated behavior change;
setting the failure cause for the propagated behavior change to the lowest order event of the FTA referring to said component behavior knowledge; and
generating the FTA knowledge including the dangerous situation of the system set to said highest order event, the request for achievement rate of the goal of the system set to the intermediate order event, and the failure cause set to the lowest order event.

3. A failure diagnosis program for a failure diagnosis device which generates information for failure diagnosis of a system by the use of MFM in a manner that said failure diagnosis program causes a computer constructing said diagnosis device to carry out processes for generating an FMEA knowledge, said computer comprising an MFM knowledge representing a flow structure achieving a goal of the system by the use of functions of components constructing said system; a component behavior knowledge including behavior changes, failure modes and failure causes when a failure occurs in a component; a dangerous situation knowledge including dangerous situations of the system, components causing said dangerous situations, and order of priority of said dangerous situations; an influence-repercussion rule that defines influence exerting when the function changes; an operation knowledge including operations of the components and behaviors caused by the operations; a request-repercussion rule that defines repercussion when request for function changes; and a function-goal knowledge representing achievement rate of the goal in a qualitative or quantitative function with respect to change in function, and
said processes for generating the FMEA knowledge to be carried out by said computer, comprising procedures of:
extracting the component, the failure mode and the failure cause included in said component behavior knowledge;
propagating behavior change of said extracted failure cause along the flow structure of the MFM knowledge in accordance with the influence-repercussion rule on the assumption that all the components except for the component of the failure cause normally operate, and deducing change in achievement rate of a goal to be achieved by function flow from the function-goal knowledge to set said change in achievement rate of the goal as the influence affecting the system;
setting the number of failure causes giving rise to dangerous situation by said extracted failure mode as the number of failure causes for respective failure modes from the component behavior knowledge;
setting order of priority of dangerous situations included in said dangerous situation knowledge as danger priority;
propagating a request for behavior change along the flow structure of the MFM knowledge in accordance with the request-repercussion rule, propagating influence when the request is fulfilled along the flow structure of the MFM knowledge in accordance with the influence-repercussion rule, and setting operation realized by the component included in the operation knowledge as counter operation for avoiding the dangerous situation;
propagating behavior change of said extracted failure cause along the flow structure of the MFM knowledge in accordance with said influence-repercussion rule, and setting behavior of the component as object of the propagation as a method for sensing the failure cause; and
generating the FMEA knowledge including the extracted component, the extracted failure mode, the extracted failure cause, the set influence affecting the system, the number of failure causes, the danger priority, the counter operation, and the method for sensing.

4. The failure diagnosis program as claimed in claim 3, said failure diagnosis program causing said computer to carry out processes further comprising procedures of:
setting the dangerous situation of the system included in said dangerous situation knowledge to the highest order event of the FTA;
propagating behavior change of the function of the component of said highest order event along the flow structure of the MFM knowledge, and setting a request for achievement rate of the goal of the system to the intermediate order event of the FTA in accordance with said propagated behavior change;
setting the failure cause for the propagated behavior change to the lowest order event of the FTA referring to said component behavior knowledge; and
generating an FTA knowledge including the dangerous situation of the system set to said highest order event, the request for achievement rate of the goal of the system set to the intermediate order event, and the failure cause set to the lowest order event.

5. A storage medium in which the failure diagnosis program claimed in claim 3 has been recorded.

6. A storage medium in which the failure diagnosis program claimed in claim 4 has been recorded.
